(19) United States
(12) Patent Application Publication
(10) Pub. No.: US 2024/0355250 A1
(43) Pub. Date: Oct. 24, 2024

(54) DISPLAY PANEL AND DISPLAY APPARATUS

(71) Applicant: Tianma Advanced Display Technology Institute (Xiamen) Co., Ltd., Xiamen (CN)

(72) Inventors: Zhenyu JIA, Xiamen (CN); Ying ZHAO, Xiamen (CN); Xin LI, Xiamen (CN); Kerui XI, Xiamen (CN); Tianyi WU, Xiamen (CN); Wenxin JIANG, Xiamen (CN); Xiaoxiang HE, Xiamen (CN); Yingteng ZHAI, Xiamen (CN); Ping AN, Xiamen (CN); Shouzheng WU, Xiamen (CN); Xueling LI, Xiamen (CN)

(21) Appl. No.: 18/757,593

(22) Filed: Jun. 28, 2024

(30) Foreign Application Priority Data
Oct. 30, 2023 (CN) 202311424811.X

(51) Int. Cl. G09G 3/00; G09G 3/32

(52) U.S. Cl. CPC G09G 3/006; G09G 3/32; G09G 2310/0275; G09G 2330/12

(57) ABSTRACT

A display panel and a display apparatus are provided. The display panel has a display region. The display panel includes in the display region: a plurality of data lines, a plurality of test switches, a plurality of test signal lines and a plurality of test control lines. One of the plurality of test switches includes an input terminal electrically connected to one of the plurality of test signal lines, an output terminal electrically connected to one of the plurality of data lines, and a control terminal electrically connected to one of the plurality of test control lines.

### CROSS-REFERENCE TO RELATED DISCLOSURE

The present disclosure claims priority to Chinese Patent Application No. 202311424811.X, filed on Oct. 30, 2023, the content of which is incorporated herein by reference in its entirety.

### TECHNICAL FIELD

This disclosure relates to the field of display technologies, and in particular to a display panel and a display apparatus.

### BACKGROUND

After the display panel is packaged and before the driving chip (IC) or the flexible circuit board (FPC) is crimped to the display panel, the display panel needs to perform a lighting test to avoid binding the IC or the FPC to the display panel that does not meet the quality standard. FIG. 1 is a schematic diagram of a display panel in the related art, as shown in FIG. 1, in order to realize a lighting test, a test circuit CT is usually provided on a lower frame NA of the display panel, and the test circuit CT includes a test switch and the like.

However, with the increasing requirements of display panels such as narrow frame and even no frame, the lower frame of the display panel is narrower and narrower, and even completely cut off. For example, in the display apparatus with a spliced screen, in order to minimize the visibility of the spliced seam, the display panel in the display apparatus is usually of a frameless design, that is, in the manufacturing process of the display panel, when the motherboard is cut into a child board, there is no lower frame, and if a lower frame is further provided for a test switch or the like required for the lighting test, the lighting test cannot be performed.

### SUMMARY

In a first aspect, embodiments of the present disclosure provide a display panel. The display panel has a display region. The display panel includes in the display region: a plurality of data lines, a plurality of test switches, a plurality of test signal lines and a plurality of test control lines. One of the plurality of test switches includes an input terminal electrically connected to one of the plurality of test signal lines, an output terminal electrically connected to one of the plurality of data lines, and a control terminal electrically connected to one of the plurality of test control lines.

In a second aspect, embodiments of the present disclosure provide a display apparatus. The display apparatus includes a display panel. The display panel has a display region. The display panel includes in the display region: a plurality of data lines, a plurality of test switches, a plurality of test signal lines and a plurality of test control lines. One of the plurality of test switches includes an input terminal electrically connected to one of the plurality of test signal lines, an output terminal electrically connected to one of the plurality of data lines, and a control terminal electrically connected to one of the plurality of test control lines.

### BRIEF DESCRIPTION OF DRAWINGS

In order to more clearly describe the technical solutions of the embodiments of this disclosure, the following briefly describes the accompanying drawings that need to be used in the embodiments, and obviously, the accompanying drawings described below are merely some embodiments of this disclosure, and for a person of ordinary skill in the art, other accompanying drawings may be obtained based on these accompanying drawings.

FIG. 1 is a schematic diagram of a display panel in the related art;

FIG. 2 is a schematic diagram of a display panel according to an embodiment of the present disclosure;

FIG. 3 is an equivalent circuit diagram of a part of circuits in the SS region in FIG. 2;

FIG. 4 is a schematic diagram of a display panel according to an embodiment of the present disclosure;

FIG. 5 is a schematic diagram of a display panel according to an embodiment of the present disclosure;

FIG. 6 is a schematic diagram of a display panel according to an embodiment of the present disclosure;

FIG. 7 is a layout structure of test switches according to an embodiment of the present disclosure;

FIG. 8 is a cross-sectional view along A1-A2 direction in FIG. 7 according to an embodiment of the present disclosure;

FIG. 9 is a schematic diagram of a light extraction structure in a display panel according to an embodiment of the present disclosure;

FIG. 10 is a schematic diagram of a light extraction structure in a display panel according to an embodiment of the present disclosure;

FIG. 11 is a layout structure of test switches according to an embodiment of the present disclosure;

FIG. 12 is a schematic diagram of a display panel according to an embodiment of the present disclosure;

FIG. 13 is a partial layout design of FIG. 12 according to an embodiment of the present disclosure;

FIG. 14 is a cross-sectional view along line C1-C2 in FIG. 13 according to an embodiment of the present disclosure;

FIG. 15 is a schematic diagram of a display panel according to an embodiment of the present disclosure;

FIG. 16 is a cross-sectional view along line B1-B2 in FIG. 13 according to an embodiment of the present disclosure;

FIG. 17 is a schematic diagram of a display panel according to an embodiment of the present disclosure;

FIG. 18 is a schematic diagram of a display panel according to an embodiment of the present disclosure;

FIG. 19 is a partial layout design of FIG. 18 according to an embodiment of the present disclosure;

FIG. 20 is a cross-sectional view along line D1-D2 in FIG. 19 according to an embodiment of the present disclosure;

FIG. 21 is a cross-sectional view along line E1-E2 in FIG. 19 according to an embodiment of the present disclosure;

FIG. 22 is a schematic diagram of a display panel according to an embodiment of the present disclosure;

FIG. 23 is a partial schematic diagram of a display panel according to an embodiment of the present disclosure;

FIG. 24 is a partial schematic diagram of a display panel according to an embodiment of the present disclosure;

FIG. 25 is a partial schematic diagram of a display panel according to an embodiment of the present disclosure;

FIG. 26 is a schematic diagram of a display panel according to an embodiment of the present disclosure;

FIG. 27 is a schematic diagram of a display panel according to an embodiment of the present disclosure;

FIG. 28 is a schematic diagram of a display panel according to an embodiment of the present disclosure;

FIG. 29 is a schematic diagram of a display panel according to an embodiment of the present disclosure;

FIG. 30 is a schematic diagram of a display panel according to an embodiment of the present disclosure;

FIG. 31 is a schematic diagram of a display panel according to an embodiment of the present disclosure;

FIG. 32 is a schematic diagram of a display apparatus according to an embodiment of the present disclosure; and

FIG. 33 is a schematic diagram of a display apparatus according to an embodiment of the present disclosure.

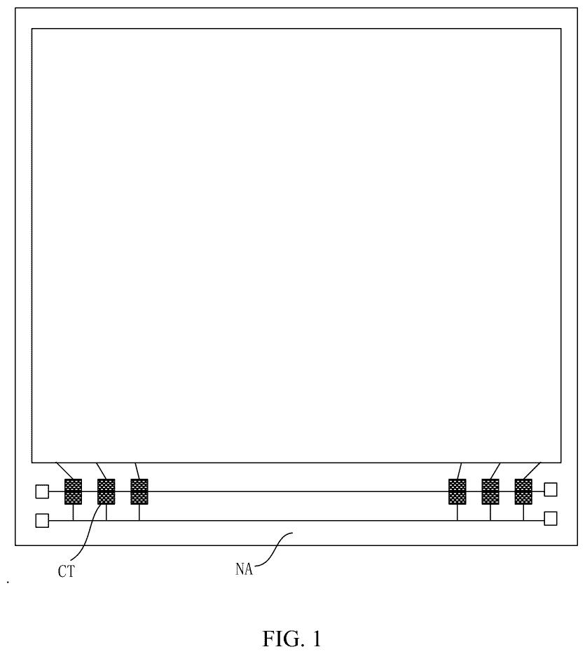

### DESCRIPTION OF EMBODIMENTS

In order to better understand the technical solutions of the present disclosure, embodiments of the present disclosure are described in detail as follows with reference to the accompanying drawings.

It should be noted that, the described embodiments are merely some but not all of the embodiments of the present disclosure. All other embodiments obtained by a person of ordinary skill in the art based on the embodiments of the present disclosure without creative efforts shall fall within the protection scope of the present disclosure.

The terms used in the embodiments of the present disclosure are for the purpose of describing specific embodiments only, and are not intended to limit the present disclosure. As used in the embodiments and the appended claims of the present disclosure, the singular forms of “a/an”, “the”, and “said” are intended to include plural forms, unless otherwise clearly specified by the context.

It should be understood that the term “and/or” used in the present disclosure represents an association relationship to describe associated objects, and can indicate three relationships, for example, A and/or B can indicate A alone, A and B, and B alone. In addition, the character “/” herein generally indicates an “or” relationship between the associated objects.

In the description of this specification, it should be understood that the terms such as “substantially”, “approximate to”, “approximately”, “about”, “roughly”, and “in general” described in the claims and embodiments of the present disclosure mean general agreement within a reasonable process operation range or tolerance range, rather than an exact value.

It should be understood that although the terms ‘first’, ‘second’ and ‘third’ may be used in the present disclosure to describe pins, these pins should not be limited to these terms. These terms are used only to distinguish the pins from each other. For example, without departing from the scope of the embodiments of the present disclosure, a first pin may also be referred to as a second pin. Similarly, the second pin may also be referred to as the first pin.

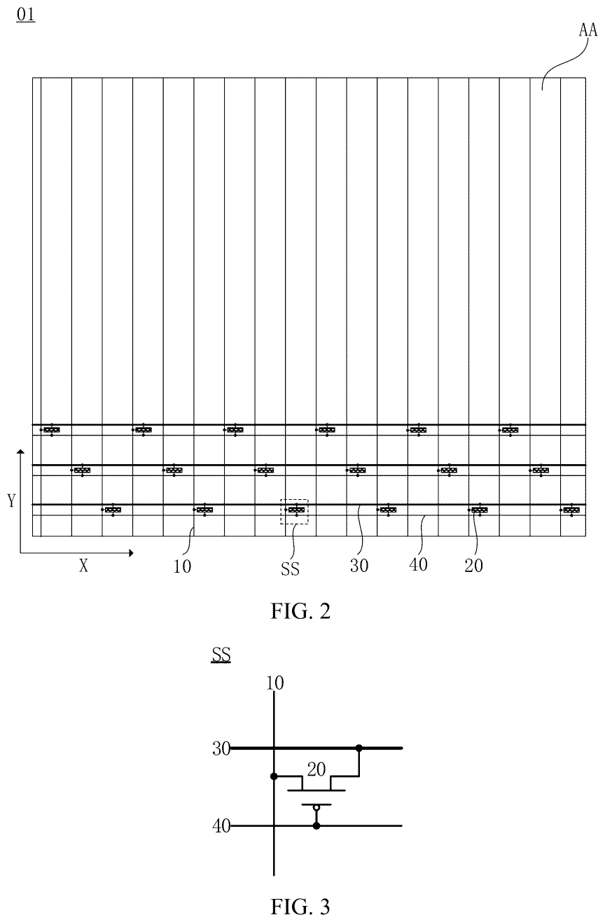

FIG. 2 is a schematic diagram of a display panel according to an embodiment of the present disclosure, and FIG. 3 is an equivalent circuit diagram of some circuits in an SS region in FIG. 2 according to an embodiment of the present disclosure.

As shown in FIG. 2, the display panel 01 provided by some embodiments of the present disclosure includes a display region AA. The display region AA includes a plurality of light-emitting devices. The display region AA is a main region of the display panel 01 for light-emitting display, and the display region AA is configured to display an image. In the display region AA, the display panel 01 includes a plurality of data lines 10, a plurality of test switches 20, test signal lines 30 and test control lines 40. As shown in FIG. 3, the test switch 20 has an input terminal electrically connected to the test signal line 30, an output terminal electrically connected to the data lines 10, and a control terminal electrically connected to the test control lines 40.

As shown in FIG. 3, the test switch 20 may be a transistor. A gate electrode of the transistor serves as a control terminal of the test switch 20, a first electrode (for example, a source electrode) of the transistor serves as an input terminal of the test switch 20, and a second electrode (for example, a drain electrode) of the transistor serves as an output terminal of the test switch 20.

The data line 10 is configured to transmit a data voltage, and a magnitude of the data voltage is a main factor for determining the brightness of the light-emitting device.

The test switch 20 is configured to perform a lighting test on the display panel 01. When the control signal transmitted by the test control line 40 controls the test switch 20 to be turned on and the test signal line 30 transmits a test signal to the test switch 20, the data line 10 electrically connected to the test switch 20 receives the test signal and controls the corresponding light-emitting device to emit light, thereby achieving the lighting test.

In some embodiments of the present disclosure, the test switch 20, the test signal line 30 and the test control line 40 in the main structure for achieving the lighting test are provided in the display region AA, so that the test switch 20, the test signal line 30 and the test control line 40 are prevented from being provided in the lower frame region of the display panel 01, the frameless design of the display panel 01 is easy to realize, and meanwhile, even if the lower frame region of the display panel 01 is cut, the test switch 20, the test signal line 30 and the test control line 40 still exist in the display panel 01, which can complete the lighting test.

In order to distinguish the test signal line 30 and the test control line 40, the widths of the test signal line 30 and the test control line 40 in FIG. 2 and FIG. 3 are illustrated with different thicknesses. In addition to the embodiments related to the widths of the test signal line 30 and the test control line 40 in the technical solutions, the widths of the test signal line 30 and the test control line 40 corresponding to other embodiments and similar to FIG. 2 and FIG. 3 are different only for distinguishing the two.

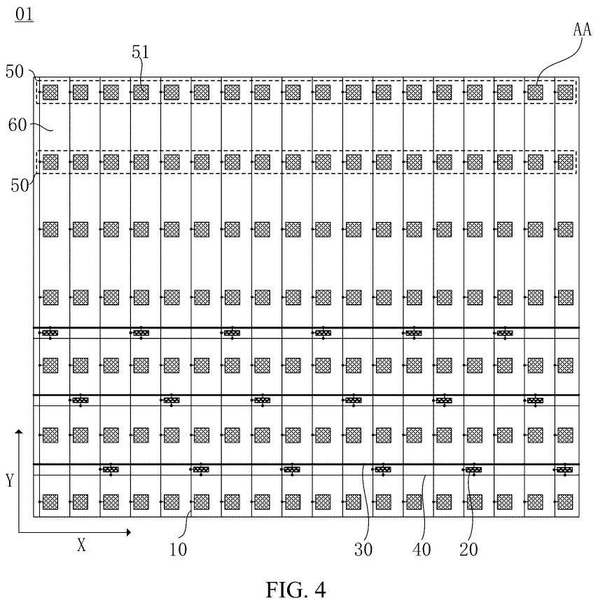

FIG. 4 is a schematic diagram of a display panel according to an embodiment of the present disclosure.

In an embodiment of the present disclosure, as shown in FIG. 4, the plurality of data lines 10 are arranged in the display region AA along the first direction X, and in addition, the data lines 10 may extend generally along the second direction Y. The second direction Y intersects the first direction X, for example, the second direction Y may be perpendicular to the first direction X.

In some embodiments of the present disclosure, the display panel 01 further includes a plurality of pixel circuit groups 50 arranged along the second direction Y, and the pixel circuit group 50 includes a plurality of pixel circuits 51 arranged along the first direction X. For example, as shown in FIG. 4, a plurality of pixel circuits 51 arranged in the row direction form one pixel circuit group 50, that is, one row of pixel circuits 51 may be regarded as one pixel circuit group 50.

In addition, along the second direction Y, a spacing region 60 is included between adjacent pixel circuit groups 50, that is, a region in which no pixel circuit 51 is provided between adjacent pixel circuit groups 50 along the second direction Y includes the spacing region 60. For example, as shown in FIG. 4, a region between two adjacent rows of pixel circuit groups 50 includes a spacing region 60. Alternatively, a region between two adjacent rows of pixel circuit groups 50 may be regarded as a spacing region 60.

In some embodiments of the present disclosure, the test switch 20 is located in the spacing region 60, that is, the test switch 20 located in the display region AA is located in a region between two pixel circuit groups 50 adjacently arranged along the second direction Y.

Since the extending direction of the data line 10 intersects the first direction X, the test switch 20 electrically connected to the data line 10 and the data line 10 are arranged along the first direction X, so that the electrical connection between the test switch 20 and the data line 10 is easy to be realized. In addition, the pixel circuit 51 is complex in structure near the connection position of the data line 10, and the conductive structures are closely arranged, so that it is difficult to add a switch (such as a transistor). Therefore, the test switch 20 is provided in the spacing region 60, so it is less difficult to provide the test switch 20 and easily electrically connected to the data line 10. In addition, since the plurality of data lines 10 are arranged along the first direction X and the plurality of test switches 20 are respectively electrically connected to different data lines 10, when at least a part of the test switches 20 are arranged along the first direction X, the difficulty of the arrangement of the test switches 20 can be reduced, and at this time, the design that the test switches 20 arranged along the first direction X are provided in the spacing region 60 is easier.

In some embodiments of the present disclosure, the plurality of test switches 20 electrically connected to a same test signal line 30 are located in a same spacing region 60, and the plurality of test switches 20 electrically connected to a same test signal line 30 may be basically electrically connected to a same test signal line 30 in a same connection mode, which reduces design difficulty and process difficulty. For example, as shown in FIG. 4, the display region AA may include a plurality of test signal lines 30, and any test signal line 30 is electrically connected to a plurality of test switches 20, and the plurality of test switches 20 electrically connected to any test signal line 30 may be located in a same spacing region 60, therefore, the test switches 20 may be basically electrically connected to a same test signal line 30 in a same connection mode.

The spacing regions 60 provided with the test switches 20 may be provided adjacent to each other or may be provided at intervals, for example, the spacing regions 60 that are not provided with the test switches 20 may be provided between the two spacing regions 60 that are provided with the test switches 20.

In some embodiments of the present disclosure, the plurality of data lines 10 are

arranged along the first direction X, and the plurality of pixel circuit groups 50 are also arranged along the first direction X. The pixel circuit group 50 includes a plurality of pixel circuits 51 arranged along the second direction Y intersecting the first direction X. A spacing region 60 is provided between adjacent pixel groups 50. The test switch 20 located in the display region AA may be located in a region between two pixel circuit groups 50 adjacently arranged along the first direction X.

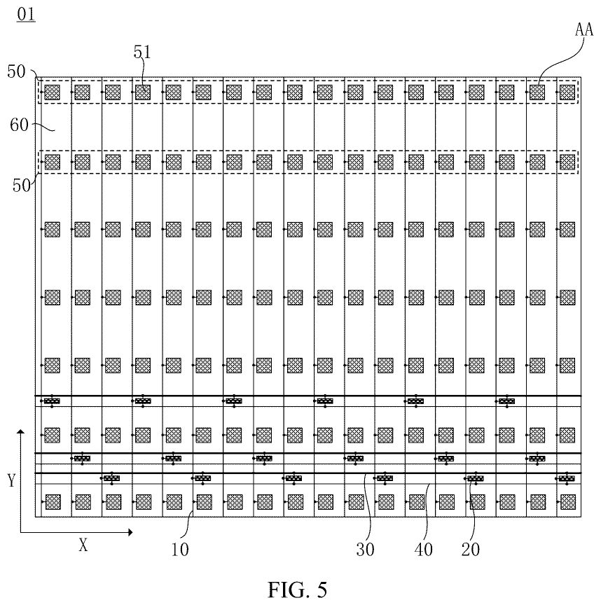

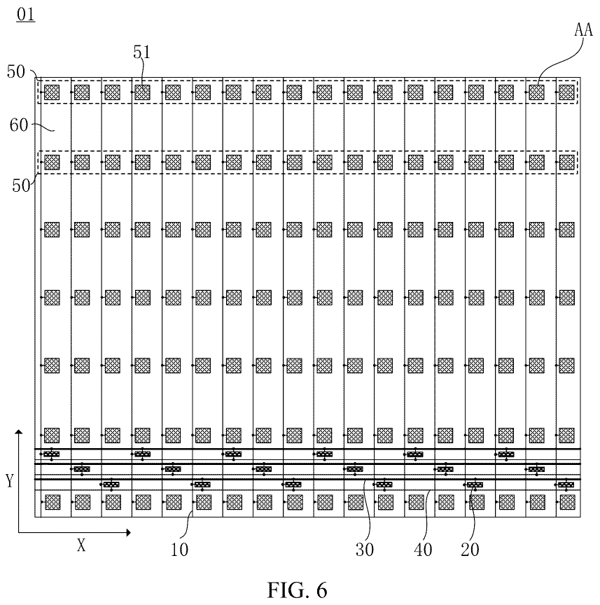

FIG. 5 is a schematic diagram of a display panel according to an embodiment of the present disclosure, and FIG. 6 is a schematic diagram of a display panel according to an embodiment of the present disclosure.

In some embodiments of the present disclosure, as shown in FIG. 5 and FIG. 6, test switches 20 respectively electrically connected to at least two different test signal lines 30 are located in a same spacing region 60. In this way, the test switches 20 may be concentrated relatively to reduce the influence of the test switch 20 on other circuits after being provided in the display region AA.

In an embodiment of the present disclosure, as shown in FIG. 5, test switches 20 respectively electrically connected to at least two test signal lines 30 are located in a same spacing region 60, and at least one test switch 20 electrically connected to a test signal line 30 different from the at least two test signal lines 30 described above is located in another spacing region 60. For example, as shown in FIG. 5, test switches 20 respectively electrically connected to two test signal lines 30 are located in a same spacing region 60, and a test switch 20 electrically connected to another test signal line 30 is located in another spacing region 60.

In an embodiment of the present disclosure, as shown in FIG. 6, test switches 20 respectively electrically connected to all test signal lines 30 are located in a same spacing region 60. For example, as shown in FIG. 6, the display region AA includes three test signal lines 30, and the test switches 20 respectively electrically connected to the three test signal lines 30 are all located in a same spacing region 60.

In some embodiments of the present disclosure, test switches 20 electrically connected to different test signal lines 30 are located in different spacing regions 60, that is, test switches 20 located in a same spacing region 60 are electrically connected to a same test signal line 30. For example, as shown in FIG. 4, the display region AA includes three test signal lines 30, and in the three test signal lines 30, test switches 20 electrically connected to any one of the test signal lines 30 are located in a same spacing region 60, and test switches 20 electrically connected to different test signal lines 30 are located in different spacing regions 60.

In an embodiment of the present disclosure, as shown in FIG. 4 to FIG. 6, the test signal line 30 and the test control line 40 are located in the spacing region 60, that is, the test signal line 30 and the test switch 20 located in the display region AA are located in a region between two pixel circuit groups 50 adjacently arranged along the second direction Y. The same test signal line 30 is generally electrically connected to the plurality of test switches 20 and the test control line 40 is generally electrically connected to the plurality of test switches 20, and when the test switches 20 are provided in the spacing region 60, the test signal line 30 and the test control line 40 electrically connected thereto are also provided in the spacing region 60, so that electrical connection between the test signal line 30 and the test control line 40 is easy to be achieved.

In some embodiments of the present disclosure, the test switch 20, and the test signal line 30 and the test control line 40 electrically connected thereto may be located in a same spacing region 60, so that a distance between the test switch 20 and the test signal line 30 that are electrically connected and a distance between the test switch 20 and the test control line 40 that are electrically connected are effectively reduced, thereby reducing difficulty of electrical connections between the test switch 20 and the test signal line 30 and between the test switch 20 the test control line 40.

In some embodiments of the present disclosure, as shown in FIG. 4 to FIG. 6, the plurality of data lines 10 are arranged along the first direction X, and the test signal line 30 and the test control line 40 extend along the first direction X. Since the plurality of data lines 10 are arranged along the first direction X, at least a part of the test switches 20 respectively electrically thereto are also arranged along the first direction X, so that the test signal lines 30 electrically connected to the plurality of test switches 20 extend along the first direction X to easily achieve electrical connection with the plurality of test switches 20 arranged along the first direction X, and the test control lines 40 electrically connected to the plurality of test switches 20 extend along the first direction X to easily achieve electrical connection with the plurality of test switches 20 arranged along the first direction X.

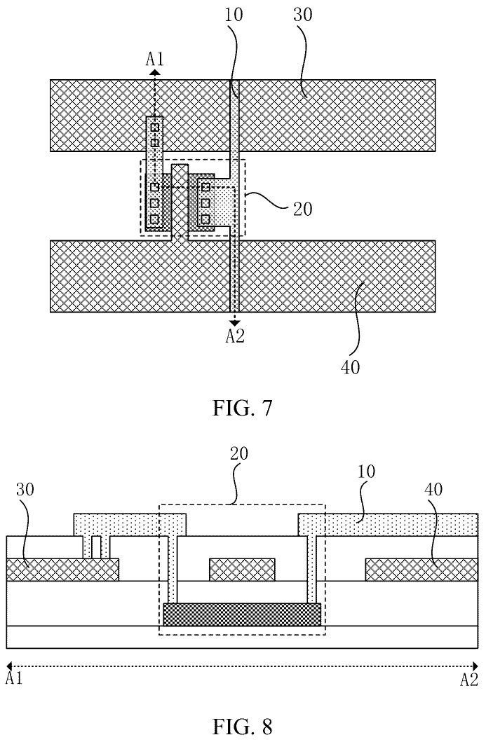

FIG. 7 is a layout structure of test switches according to an embodiment of the present disclosure, and FIG. 8 is a schematic cross-sectional view along a direction A1-A2 shown in FIG. 7 according to an embodiment of the present disclosure.

In some embodiments of the present disclosure, the test signal line 30 and the test control line 40 may be provided in a same layer. For example, with reference to FIG. 7 and FIG. 8, both the test signal line 30 and the test control line 40 may be provided in a same layer as the gate electrode (control terminal) of the test switch 20, or may be provided in a same layer as other scan lines basically extending along the first direction X in the display region AA.

The signal lines electrically connected to the pixel circuit 51 and extending along the first direction X are mostly scan lines, and the scan lines basically overlap with the pixel circuit 51 along a direction perpendicular to the plane of the display panel 01, so there are fewer signal lines extending along the first direction X in the spacing region 60, and the test signal lines 30 and the test control lines 40 are provided in a same layer and extend along a same direction, which is easy to achieve wiring and reduces process steps.

In the display panel 01, the test switches 20 electrically connected to different test signal lines 30 may transmit test signals to the data lines 10 in a time division mode, so as to perform lighting tests on different regions of the display panel 01. For example, lighting tests are performed in a time division mode on regions where red light-emitting devices are located, regions where green light-emitting devices are located, and regions where blue light-emitting devices are located. The test switch 20 may be controlled to transmit the test signal to the data line 10 in a time division mode by controlling the time when different test signal lines 30 transmit the test signal, at this time, at least a part of the test control lines 40 may be electrically connected together. That is, although at least a part of the test control lines 40 are electrically connected together, the test signal lines 30 connected to the input terminals of the test switches 20 electrically connected to the electrically connected control lines are not necessary to transmit test signals simultaneously, so that a part of the test switches 20 can still transmit test signals to the data lines 10 in a time division mode.

In some embodiments of the present disclosure, the test switches 20 electrically connected to different test signal lines 30 may also be electrically connected to different test control lines 40, that is, the test signal lines 30 and the test control lines 40 are provided in one-to-one correspondence, in this way, the test signal lines 30, the test switches 20 and the test control lines 40 may be provided in groups, and when the control signal transmitted by the test control line in each group controls the test switch 20 in the group to be turned on, the test signal transmitted by the corresponding test signal line 30 in the group is written into the data line 10.

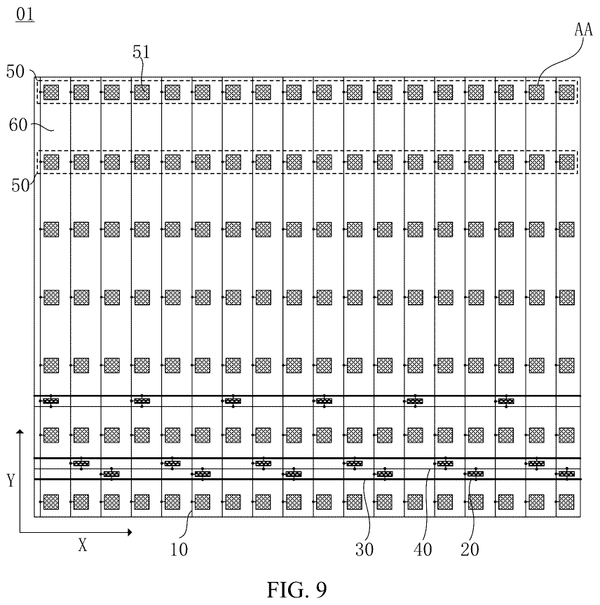

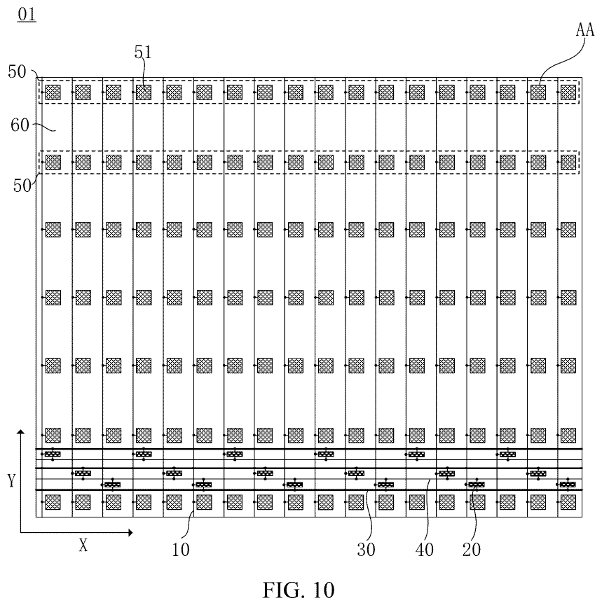

FIG. 9 is a schematic diagram of a display panel according to an embodiment of the present disclosure, and FIG. 10 is a schematic diagram of a display panel according to an embodiment of the present disclosure.

In some embodiments of the present disclosure, as shown in FIG. 9 and FIG. 10, at least two test switches 20 that are electrically connected to different test signal lines 30 are located in a same spacing region 60 and are electrically connected to a same test control line 40, that is, at least some test switches 20 are electrically connected to different test signal lines 30, but the electrically connected test control lines 40 are a same. Therefore, the number of the test control lines 40 can be reduced, and meanwhile, by controlling the timing of the signals transmitted by the test signal lines 30, the light-emitting devices corresponding to at least some different pixel circuits 51 can still perform lighting test in a time division mode.

Still referring to FIG. 9 and FIG. 10, the test switches 20 electrically connected to a same test control line 40 and electrically connected to different test signal lines 30 are located on two sides of the test control line 40. That is, in the test switches 20 electrically connected to a same test control line 40, the test switches 20 electrically connected to a same test signal line 30 are located on a same side of the test control line 40, and the test switches 20 electrically connected to different test signal lines 30 are located on different sides of the test control line 40. In this way, the test switches 20 electrically connected to a same test signal line 30 are located on a same side of the test control line 40, so that the difficulty of electrical connection between the test signal line 30 and the test switches 20 is reduced, and the risk of cross short circuit between the test signal line 30 and the test control line 40.

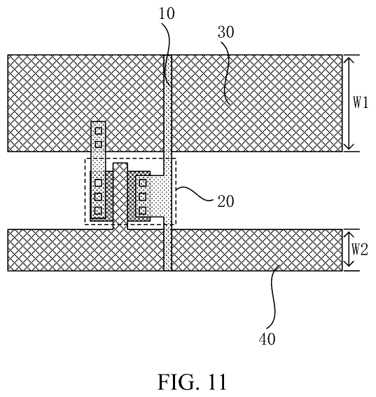

FIG. 11 is a layout structure of test switches according to an embodiment of the present disclosure.

In an embodiment of the present disclosure, as shown in FIG. 11, the width W1 of the test signal line 30 is greater than the width W2 of the test control line 40. In this embodiment, the width W2 of the test control line 40 is narrow, so as to prevent the display efficiency of the display panel 01 from being affected by the wider spacing region 60 caused by the wider arrangement of the test control line 40, and prevent excessive occupation of the space of the functional device such as the pixel circuit 51. On the other hand, the signal intensity of the test signal line 30 directly affects the lighting test effect, and the test signal line 30 is designed wider, so that the intensity of the test signal on the test signal line 30 will not be reduced too much, thereby achieving effect of the lighting test.

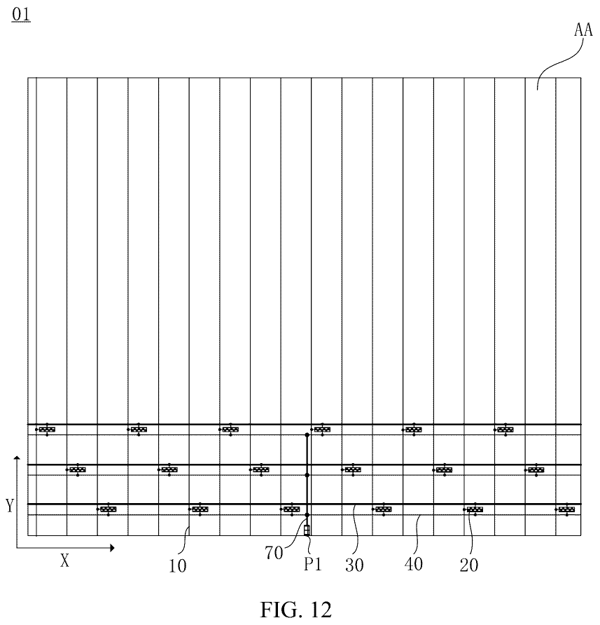

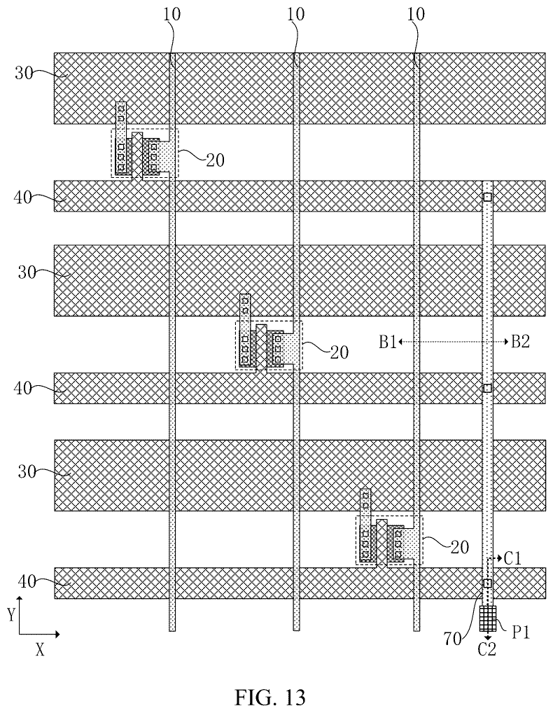

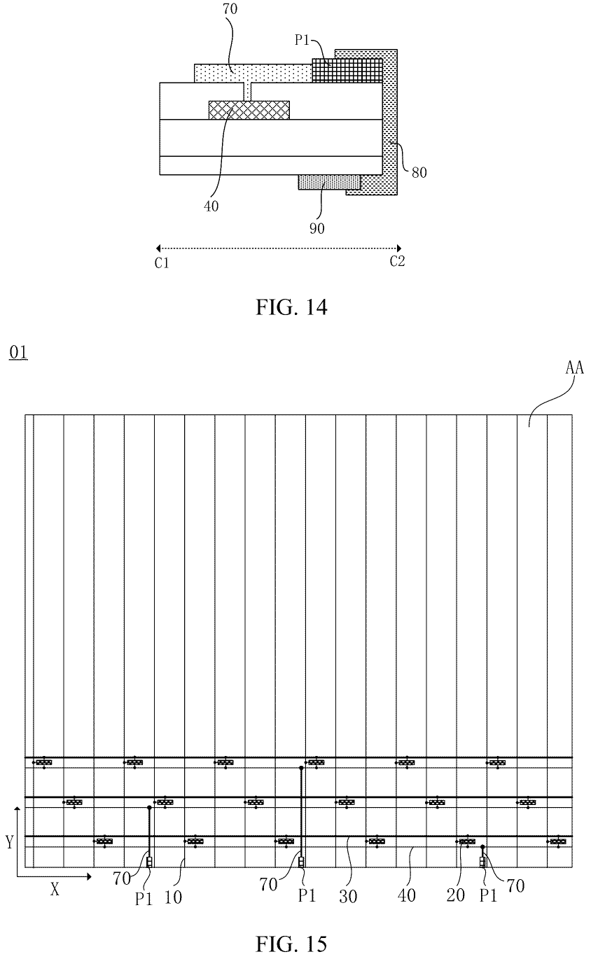

FIG. 12 is a schematic diagram of a display panel according to an embodiment of the present disclosure, FIG. 13 is a partial layout design of FIG. 12 according to an embodiment of the present disclosure, and FIG. 14 is a schematic cross-sectional view along a direction C1-C2 in FIG. 13 according to an embodiment of the present disclosure.

It should be noted that, for a drawing including pins, an example in which the pins are located in a display region (an edge of the display region) of the display panel is used for illustration. In related embodiments, the pins may also be located in a non-display region of the display panel.

Referring to FIG. 12, FIG. 13 and FIG. 14, in the display region AA, the display panel 01 further includes a control connection line 70 and a first pin P1, that is, the control connection line 70 and the first pin P1 are located in the display region AA of the display panel 01, and the control connection line 70 is provided to electrically connect the test control line 40 and with first pin P1. The first pin P1 is close to the edge region of the display panel 01, and the arrangement of the control connection line 70 enables the test control line 40 to be electrically connected to the conductive structure in the edge region of the display panel 01, thereby obtaining a required signal. As shown in FIG. 14, the control connection line 70 may be provided in a same layer as the first pin P1, or one of the control connection line 70 and the first pin P1 is first prepared before the other. The electrical connection between the control connection line 70 and the first pin P1 is achieved through overlapped layers or through an insulation layer between the control connection line 70 and the first pin P1.

The control connection line 70 may transmit a signal to the test control line 40 to control an on-off state of the test switch 20. In an embodiment of the present disclosure, after the lighting test, for example, during leaving factory, selling and using of the display panel 01, the control connection line 70 may be configured to transmit a signal for controlling the test switch 20 to be turned off, so that the test switch 20 is always kept in an off state after the lighting test, thereby avoiding an influence of structures related to the lighting test on normal display of the display panel 01.

The control connection line 70 may also transmit a signal for controlling the test switch 20 to be turned on during the lighting test, so that the test switch 20 is turned on during the lighting test. That is, the signal transmitted by the test control line 40 during the lighting test and configured to control the test switch 20 to be turned on is transmitted by the control connection line 70.

In addition, the signal transmitted by the test control line 40 in the lighting test and configured to control the test switch 20 to be turned on may also be transmitted by a test pin at at least one terminal of the test control line 40 in the extending direction, that is, at least one terminal of the test control line 40 in the extending direction includes a test pin electrically connected thereto, and the pin may be electrically connected to an external lighting test device in the lighting test, so as to obtain the signal for controlling the test switch 20 to be turned on. It should be noted that the test pins electrically connected to the test control line 40 may be cut off after the display panel 01 is packaged.

The display panel 01 further includes a first side wiring 80 and a first lower pin 90 that is located on a side of the backlight surface of the display panel 01. The first pin P1 is electrically connected to the first lower pin 90 through the first side wiring 80. The first lower pin 90 may be bound to the IC or the FPC after the lighting test, and the first lower pin 90 may also be connected to an external lighting test device during the lighting test. The first pin P1 located on the side of the light-emitting surface of the display panel 01 (or located on the upper side of the array substrate) is connected to the first lower pin 90 located on the side of the backlight surface of the display panel 01 through the first side wiring 80, so that the region occupied by the wiring is reduced, and the size of the frame is reduced.

The first lower pin 90 is provided on a side of the backlight surface of the display panel 01. In this way, on one hand, it is ensured that the first lower pin 90 has a larger region and is easy to receive signals; on the other hand, the light-emitting area of the light-emitting surface of the display panel 01 is not shielded.

The area of the first pin P1 may be smaller than the area of the first lower pin 90, and the width of the second pin P1 is greater than the width of the control connection line 70, and the arrangement of the first pin P1 between the control connection line 70 and the first side wiring 80 may ensure the electrical conduction yield between the control connection line 70 and the first side wiring. Meanwhile, the first pin P1 with a relatively small area will not greatly affect the area of the light-emitting surface of the display panel 01.

In addition, the first side wiring 80 is mainly provided on a side of the display panel and is in electrical contact with the first pin P1 and the first lower pin 90 respectively, and a material of the first side wiring 80 may be silver or copper.

In an embodiment of the present disclosure, as shown in FIG. 12 and FIG. 13, the control connection line 70 is electrically connected to at least two test control lines 40, that is, the control connection line 70 may be electrically connected to multiple test control lines 40 simultaneously. When the control connection line 70 is provided to transmit a signal for controlling the test switch 20 to be turned off after the lighting test, the test switch 20 may be controlled to be turned off by fewer control connection lines 70. When the control connection line 70 is provided to transmit a signal for controlling the test switch 20 to be turned on during the lighting test, the test switch 20 may be controlled to be turned on by fewer control connection lines 70.

In this embodiment, the control connection line 70 is electrically connected to the at least two test control lines 40, so that the number of the control connection lines 70 and the number of the first pins P1 can be relatively reduced, and the design difficulty of the display panel 01 is reduced.

FIG. 15 is a schematic diagram of a display panel according to an embodiment of the present disclosure.

In an embodiment of the present disclosure, as shown in FIG. 15, the control connection lines 70 are electrically connected to the test control lines 40 in a one-to-one correspondence, and different control connection lines 70 may separately transmit signals to different test control lines 40, to improve flexibility of a lighting test.

When the control connection line 70 transmits the signal for controlling the test switch 20 to be turned on during the lighting test, the control connection lines 70 and the test control lines 40 are electrically connected in one-to-one correspondence, so that different test control lines 40 receive the signal for controlling the test switch 20 to be turned on in a time division mode, thereby flexibly performing the lighting test. For example, if the plurality of data lines 10 include a red data line for transmitting a data signal for controlling the red light-emitting device to emit light, a green data line for transmitting a data signal for controlling the green light-emitting device to emit light, and a blue data line for transmitting a data signal for controlling the blue light-emitting device to emit light, the test control lines 40 electrically connected to the test switches electrically connected to the red, green and blue data lines may be electrically connected to different control connection lines respectively, and the different control connection lines may control the test switches electrically connected to the red, green and blue data lines to be turned on in a time division mode, thereby achieving a time division lighting test on the red, green and blue light-emitting devices.

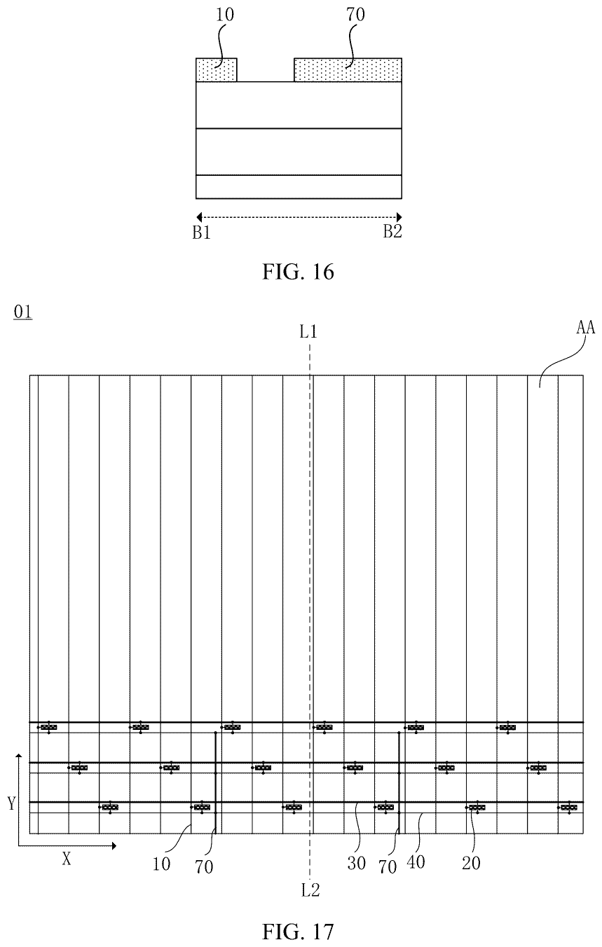

FIG. 16 is a cross-sectional view along line B1-B2 in FIG. 13 according to an embodiment of the present disclosure.

Referring to FIG. 12, FIG. 13 and FIG. 16, the control connection line 70 and the data line 10 are in a same layer and extend in parallel, so that the control connection line 70 and the data line 10 may be prepared simultaneously, thereby reducing the preparation difficulty of the control connection line 70. In addition, if the control connection line 70 extends in parallel with the data line 10, the extending direction of the control connection line 70 intersects the extending direction of the test control line 40, and electrical connection between the control connection line 70 and the test control line 40 is easy to be achieved.

FIG. 17 is a schematic diagram of a display panel according to an embodiment of the present disclosure.

In an embodiment of the present disclosure, as shown in FIG. 17, the display region AA includes at least two control connection lines 70, the at least two control connection lines 70 are arranged symmetrically about a first symmetry axis L1-L2. The first symmetry axis L1-L2 is perpendicular to the first direction X and passes through a midpoint of a plane of the display panel 01. That is, the plurality of control connection lines 70 are symmetrically distributed in the display region AA to avoid the visual difference of the display panel 01 caused by the asymmetric arrangement of the control connection lines 70.

In some embodiments of the present disclosure, as shown in FIG. 17, the display region AA includes an even number of control connection lines 70. The even number of control connection lines 70 may be evenly distributed on both sides of the first symmetry axis L1-L2.

In some embodiments of the present disclosure, as shown in FIG. 15, the display region AA includes an odd number of control connection lines 70, and in the odd number of control connection lines 70, one control connection line 70 located in the middle and an extension line thereof may overlap with the first symmetry axis L1-L2, and other control connection lines 70 may be evenly distributed on both sides of the first symmetry axis L1-L2.

In an embodiment, at least two control connection lines 70 symmetrically distributed about the first symmetry axis L1-L2 are electrically connected to a same test control line 40, for example, as shown in FIG. 17. In an embodiment, at least two control connection lines 70 symmetrically distributed about the first symmetry axis L1-L2 are electrically connected to different test control lines 40, for example, as shown in FIG. 15.

It should be noted that, when the display region AA includes one control connection line 70, the control connection line 70 and its extension line may overlap with the first symmetry axis L1-L2, and the control connection line 70 is electrically connected to all test control lines 40, for example, as shown in FIG. 12.

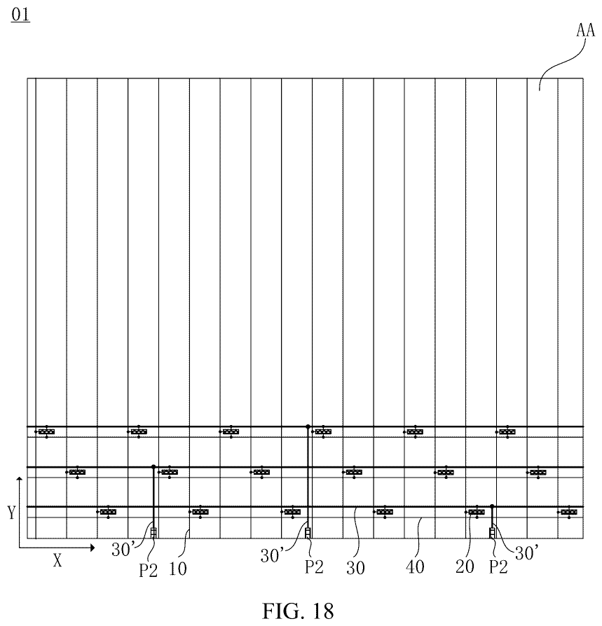

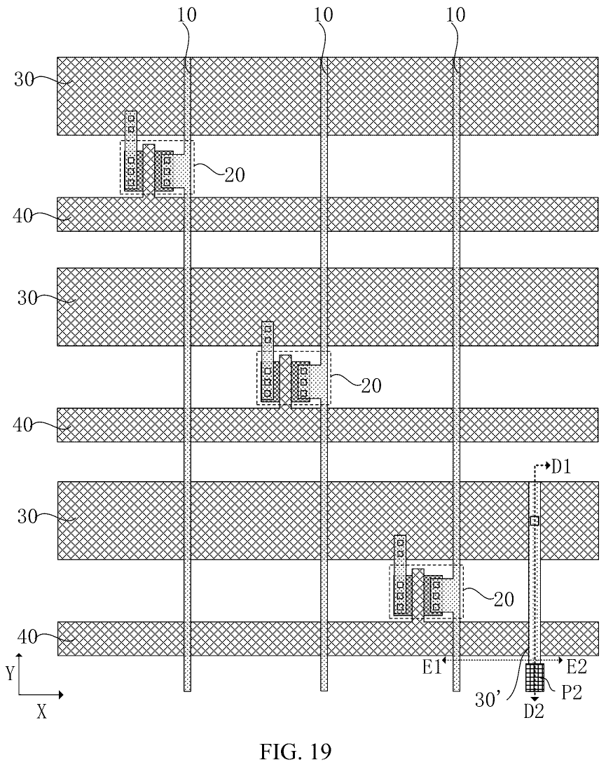

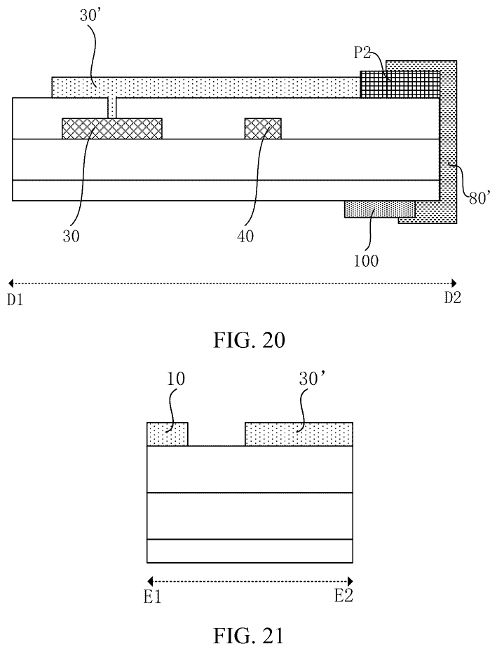

FIG. 18 is a schematic diagram of a display panel according to an embodiment of the present disclosure, FIG. 19 is a partial layout design of FIG. 18 according to an embodiment of the present disclosure, and FIG. 20 is a schematic cross-sectional view along a direction D1-D2 in FIG. 19 according to an embodiment of the present disclosure.

Referring to FIG. 18, FIG. 19 and FIG. 20, in the display region AA, the display panel 01 further includes a signal connection line 30′ and a second pin P2. That is, the signal connection line 30′ and the second pin P2 are located in the display region AA of the display panel 01. The test signal line 30 is electrically connected to the second pin P2 through the signal connection line 30′. The second pin P2 is adjacent to the edge region of the display panel 01, and the signal connection line 30′ is provided so that the test signal line 30 can be electrically connected to the conductive structure in the edge region of the display panel 01, thereby obtaining a required signal. As shown in FIG. 20, the signal connection line 30′ may be provided in a same layer as the second pin P2, or one of the signal connection line 30′ and the second pin P2 is first prepared before the other, and the signal connection line 30′ and the second pin P2 are electrically connected through overlapped layers or through an insulation layer through hole located between the signal connection line 30′ and the second pin P2.

The signal connection line 30′ may transmit the test signal during the lighting test, so that the turned on test switch 20 transmits the test signal to the data line 10, that is, the test signal transmitted by the test signal line 30 during the lighting test is transmitted by the signal connection line 30′.

In addition, the test signal transmitted by the test signal line 30 in the lighting test may also be transmitted by a test pin at at least one terminal of the test signal line 30 in the extending direction. That is, at least one terminal of the test signal line 30 in the extending direction includes a test pin electrically connected to the test signal line 30, and the test pin may be electrically connected to an external lighting test device in the lighting test, thereby obtaining the test signal. It should be noted that the test pins electrically connected to the test signal lines 30 may be cut off after the display panel 01 is packaged.

The display panel 01 further includes a second side wiring 80′ and a second lower pin 100 that is located on a side of the backlight surface of the display panel 01. The second pin P2 is electrically connected to the second lower pin 100 through the second side wiring 80′. The second lower pin 100 may be bound to the IC or the FPC after the lighting test, and the second lower pin 100 may also be connected to an external lighting test device during the lighting test.

The second lower pin 100 is provided on a side of the backlight surface of the display panel 01. In this way, on one hand, it is ensured that the second lower pin 100 has a larger area and is easy to receive signals; on the other hand, the light-emitting area of the light-emitting surface of the display panel 01 is not shielded.

The area of the second pin P2 may be smaller than the area of the second lower pin 100, but the width of the second pin P2 is smaller than the width of the signal connection line 30′. The second pin P2 can achieve the electrical conduction yield between the signal connection line 30′ and the second side wiring 80′. Meanwhile, the second pin P2 with a relative small area does not significantly affect the area of the light-emitting surface of the display panel 01.

In addition, the second side wiring 80′ is mainly provided on a side of the display panel and is in electrical contact with the second pin P2 and the second lower pin 100 respectively. The second side wiring 80′ may be made of a silver or copper material.

In an embodiment of the present disclosure, as shown in FIG. 18, the signal connection lines 30′ are electrically connected to the test signal lines 30 in one-to-one correspondence, so that different signal connection lines 30′ may transmit test signals to different test signal lines 30, respectively, to improve the flexibility of lighting test.

FIG. 21 is a cross-sectional view along line E1-E2 shown in FIG. 19 according to an embodiment of the present disclosure.

Referring to FIG. 18, FIG. 19 and FIG. 21, the signal connection line 30′ is in a same layer as the data line 10, and the extending direction of the signal connection line 30′ is parallel to the extending direction of the data line 10, so that the control connection line 30′ and the data line 10 may be prepared simultaneously, thereby reducing the preparation difficulty of the control connection line 30′. In addition, the signal connection line 30′ is parallel to the extending direction of the data line 10, so that the extending direction of the signal connection line 30′ intersects the extending direction of the test signal line 30, and electrical connection between the signal connection line 30′ and the test signal line 30 is easy to be achieved.

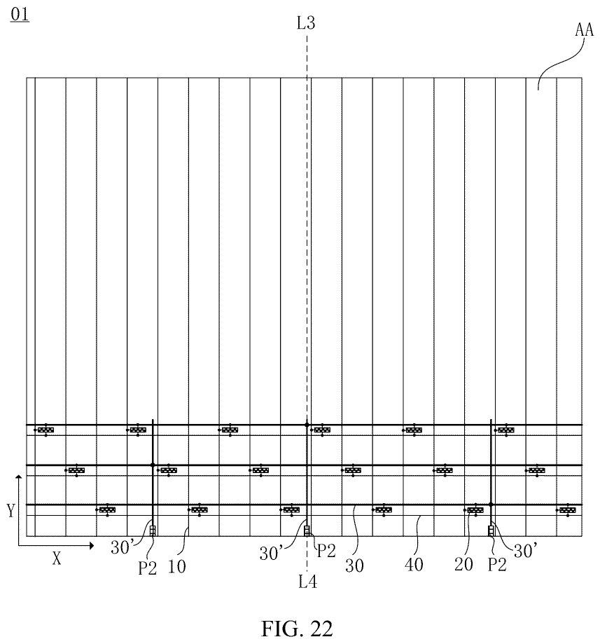

FIG. 22 is a schematic diagram of a display panel according to an embodiment of the present disclosure.

In an embodiment of the present disclosure, as shown in FIG. 22, the display region AA includes at least two signal connection lines 30′ arranged symmetrically about a second symmetry axis L3-L4. The second symmetry axis L3-L4 is perpendicular to the first direction X and passes through the midpoint of the plane of the display panel 01. That is, the plurality of signal connection lines 30′ are symmetrically distributed in the display region AA to avoid the visual difference of the display panel 01 caused by the asymmetric arrangement of the signal connection lines 30′.

It should be noted that the display region AA of the display panel 01 may include the control connection line 70 and the first pin P1 and does not include the signal connection line 30′ and the second pin P2, and the display region AA of the display panel 01 may further include the control connection line 70, the first pin P1, the signal connection line 30′ and the second pin P2 at a same time. In any case, the control connection line 70 and the first pin P1 may be designed as described in any of the above embodiments.

It should be noted that the display region AA of the display panel 01 may include the signal connection line 30′ and the second pin P2 and does not include the control connection line 70 and the first pin P1, and the display region AA of the display panel 01 may further include both the signal connection line 30′ and the second pin P2, the control connection line 70 and the first pin P1 at a same time. In any case, the design of the signal connection line 30′ and the second pin P2 may be as described in any of the above embodiments.

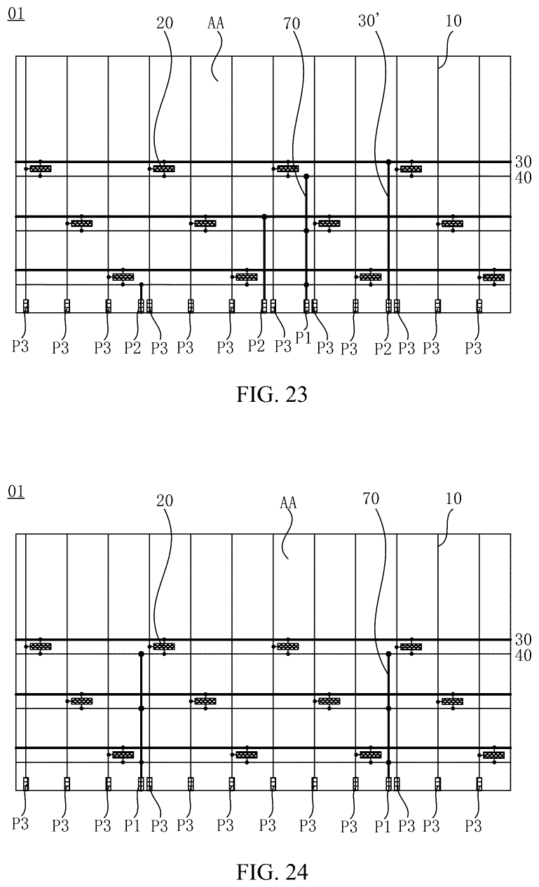

FIG. 23 is a partial schematic diagram of a display panel according to an embodiment of the present disclosure.

As shown in FIG. 23, the display region AA of the display panel 01 further includes a third pin P3, and the data line 10 is electrically connected to the third pin P3. The third pin P3 may be electrically connected to the third lower pin P3′ on the side of the backlight surface of the display panel 01 through the third side wiring, and the data line 10 may obtain the data voltage for display through the third lower pin P3′, the third side wiring, and the third pin P3 bound to the IC or FPC.

In an embodiment of the present disclosure, as shown in FIG. 23, when the display panel 01 includes the first pin P1 and the second pin P2, a third pin P3 is included between the first pin P1 and the second pin P2. That is, the first pin P1 and the second pin P2 are not adjacent to each other. Such a design can avoid the difficulty caused by the concentrated arrangement of the first pin P1 and the second pin P2 to the arrangement of the third pins P3. Especially, the dispersed arrangement of the first pin P1 and the second pin P2 can avoid the data line 10 connected to the third pin P3 from providing a sector wiring design. In addition, the first lower pin 90 and the second lower pin 100 are not adjacent to each other, so that the first lower pin 90 and the second lower pin 100 are easily distinguished and not confused during the lighting test.

FIG. 24 is a partial schematic diagram of a display panel according to an embodiment of the present disclosure.

In an embodiment of the present disclosure, as shown in FIG. 24, when the display panel 01 includes a plurality of first pins P1. A third pin P3 is included between adjacent first pins P1, that is, the plurality of first pins P1 are not adjacent to each other. Such a design can avoid the difficulty of the arrangement of the third pins P3 caused by the concentrated arrangement of the first pins P1. Especially, the dispersed arrangement of the first pins P1 can avoid the data lines 10 connected to the third pins P3 from providing a sector wiring design. In addition, the corresponding first lower pins 90 are not adjacent to each other, so that different first lower pins 90 are easily distinguished and not confused during the lighting test.

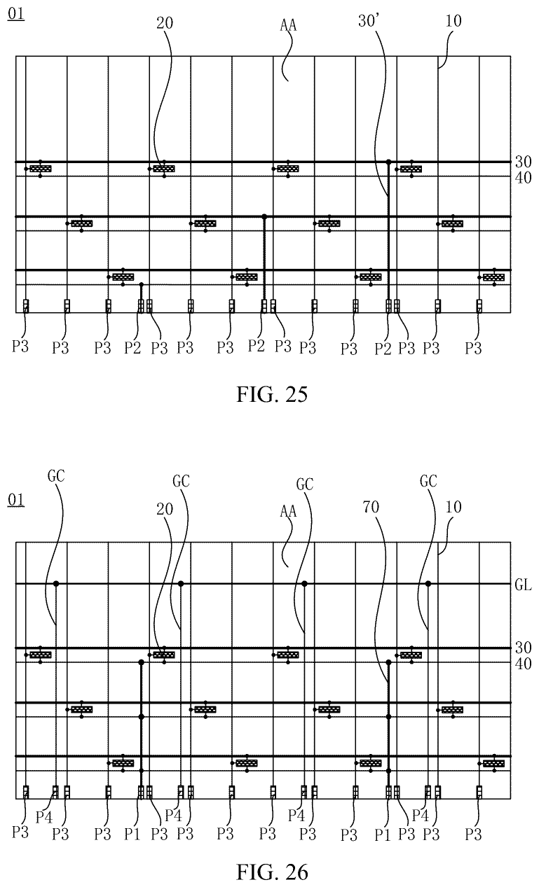

FIG. 25 is a partial schematic diagram of a display panel according to an embodiment of the present disclosure.

In an embodiment of the present disclosure, as shown in FIG. 25, when the display panel 01 includes a plurality of second pins P2, a third pin P3 is included between adjacent second pins P2, that is, the plurality of second pins P2 are not adjacent to each other. Such a design can avoid the difficulty caused by the concentrated arrangement of the second pins P2 to the arrangement of the third pins P3. Especially, the dispersed arrangement of the second pins P2 can avoid the data lines 10 connected to the third pins P3 from providing a sector wiring design. In addition, the corresponding second lower pins 100 are not adjacent to each other, so that different second lower pins 100 are easily distinguished and not confused during the lighting test.

In an embodiment of the present disclosure, the display panel 01 includes a plurality of first pins P1 and a plurality of second pins P2, so that a third pin P3 is included between adjacent first pins P1, and a third pin P3 is included between adjacent second pins P2, and/or a third pin P3 is included between first pin P1 and second pin P2 adjacent to each other.

It should be noted that when the display panel 01 includes a plurality of first pins P1, the display region AA includes a plurality of control connection lines 70. In an embodiment of the present disclosure, the plurality of control connection lines 70 are electrically connected to a same test control line 40, for example, as shown in FIG. 23 and FIG. 24. In an embodiment of the present disclosure, the plurality of control connection lines 70 are electrically connected to different test control lines 40, for example, as shown in FIG. 15.

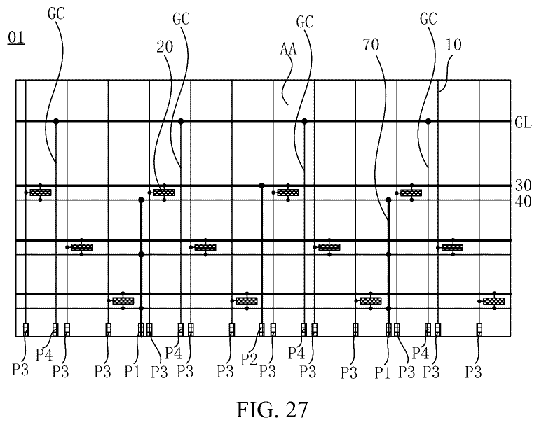

FIG. 26 is a schematic diagram of a display panel according to an embodiment of the present disclosure, and FIG. 27 is a schematic diagram of a display panel according to an embodiment of the present disclosure.

In the display region AA, the display panel 01 further includes a driving circuit wiring GL, and the driving circuit wire GL may be electrically connected to the shift register circuit and may be a clock signal line, a high-level signal line, a low-level signal line, or the like. The shift register circuit may also be located in the display region AA.

The driving circuit wire GL may extend along the first direction X and may be located in the spacing region 60, and the driving circuit wiring GL may be located in a different spacing region 60 from the test switch 20, the test signal line 30 and the test control line 40, thereby reducing the design difficulty of the display panel 01.

In addition, the display panel 01 further includes a driving circuit connection line GC and a fourth pin P4. The driving circuit wiring GL is electrically connected to the first pin P1 through the driving circuit connection line. The fourth pin P4 may be electrically connected with a fourth lower pin on a side of the backlight surface of the display panel 01 through a fourth side wiring. The fourth lower pin may be bound to the IC or the FPC, and the driving circuit wiring GL may receive a corresponding signal through the fourth pin P4, the fourth side wiring and the fourth lower pin.

A first pin P1 and/or a second pin P2 are included between at least some adjacent fourth pins P4. As shown in FIG. 26, a first pin P1 is included between two adjacent fourth pins P4. As shown in FIG. 27, a first pin Pl and a second pin P2 between two adjacent fourth pins P4. In some embodiments, a second pin P2 may be included between two adjacent fourth pins P4.

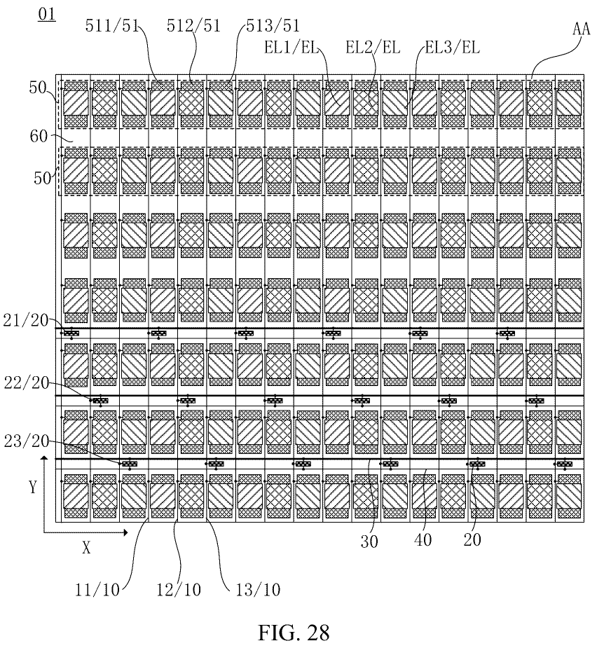

FIG. 28 is a schematic diagram of a display panel according to an embodiment of the present disclosure.

In the display region AA, the display panel 01 further includes a light-emitting device EL and a pixel circuit 51. The light-emitting device EL may be at least one of an organic light-emitting device (OLED), a Micro-LED, and a Mini-LED.

The light-emitting device EL includes a first color emitting device EL1 and a second color emitting device EL2 with different light-emitting colors. The pixel circuit 51 includes a first pixel circuit 511 and a second pixel circuit 512. The first pixel circuit 511 is electrically connected to the first color light-emitting device EL1, and the second pixel circuit 512 is electrically connected to the second color light-emitting device EL2. That is, the first pixel circuit 511 drives the first color light-emitting device ELI to emit the first color light, and the second pixel circuit 512 can drive the second color light-emitting device EL2 to emit the second color light.

The plurality of data lines 10 include a first data line 11 and a second data line 12. The first data line 11 is electrically connected to the first pixel circuit 511, and the second data line 12 is electrically connected to the second pixel circuit 512. That is, the first data line 11 transmits the data voltage related to the brightness of the first color light-emitting device EL1, and the second data line 12 transmits the data voltage related to the brightness of the second color light-emitting device EL2.

The plurality of test switches 20 includes a first test switch 21 and a second test switch 22. An output terminal of the first test switch 21 is electrically connected to the first data line 11, and an output terminal of the second test switch 22 is electrically connected to the second data line 12. That is, the first test switch 21 is provided to perform a lighting test on the first color light-emitting device EL1 in the display panel 01, and the second test switch 22 is provided to perform a lighting test on the second color light-emitting device EL2 in the display panel 01.

The first test switch 21 and the second test switch 22 are respectively electrically connected to different test signal lines 30, that is, the lighting test on the first color light-emitting device EL1 and the lighting test on the second color light-emitting device EL2 may provide test signals by different test signal lines 30, and then the display panel 01 performs the first color image lighting test and the second color image lighting test. For example, if the first color light-emitting device EL1 is a red light-emitting device EL, and the second color light-emitting device EL2 is a green light-emitting device EL, the display panel 01 performs a red image lighting test and a green image lighting test, respectively.

In addition, the display region AA of the display panel 01 may further include a third color light-emitting device EL3, a third pixel circuit 513, a third data line 13, and a third test switch 23. The third color light-emitting device EL3 is electrically connected to the third pixel circuit 513, the third data line 13 is electrically connected to the third pixel circuit 513, and the third test switch 23 is electrically connected to the third data line 13. The test signal line 30 connected to the third test switch 23 may be different from the test signal line 30 electrically connected to the first test switch 21 and the second test switch 22, and the third test switch 23 may perform a third color image lighting test on the display panel 01.

It should be noted that the display panel 01 may include light-emitting devices EL of three colors and corresponding pixel circuits 51 and test switches 20, or may further include light-emitting devices EL of two colors and corresponding pixel circuits 51 and test switches 20, or may include light-emitting devices EL of other colors and corresponding pixel circuits 51 and test switches 20.

In an embodiment of the present disclosure, the test switches 20 for controlling a same color image lighting test may be located in a same spacing region 60. For example, the first test switch 21 is located in a same spacing region 60, the second test switch 22 is located in a same spacing region 60, and the third test switch 23 is located in a same spacing region 60.

In an embodiment of the present disclosure, the test switches 20 for controlling lighting tests of different colors may be located in a same spacing region 60. That is, at least a part of the first test switches 21 and at least a part of the second test switches 22 are located in a same spacing region 60. When the display panel 01 further includes the third test switches 23, at least a part of the first test switches 21, at least a part of the second test switches 22, and at least a part of the third test switches 23 are located in a same spacing region 60. For example, the first test switch 21, the second test switch 22, and the third test switch 23 are located in a same spacing region 60.

In an embodiment of the present disclosure, the test switches 20 for controlling different color image lighting tests may be located in different spacing regions 60. That is, the first test switch 21 and the second test switch are located in different spacing regions 60. When the display panel 01 further includes the third test switch 23, the first test switch 21, the second test switch 22, and the third test switch 23 are respectively located in different spacing regions 60.

In an embodiment of the present disclosure, the test switches 20 for controlling a part of different color picture lighting tests may be located in different spacing regions 60, and the test switches 20 for controlling a part of different color image lighting tests may be located in a same spacing region 60. That is, in the first test switch 21, the second test switch 22, and the third test switch 23, at least a part of at least two of the three are located in a same spacing region 60, and at least a part of at least two of the three are located in different spacing regions 60. For example, the second test switch 22 and the third test switch 23 are located in a same spacing region 60, and the first test switch 21 and the second test switch 22 are located in different spacing regions 60.

In an embodiment of the present disclosure, as shown in FIG. 28, the at least two first test switches 21 are connected to a same test signal line 30, that is, the at least two test switches 20 may simultaneously transmit test signals to the at least two first data lines 11, so that the first color light-emitting devices EL1 electrically connected to the at least two first data lines 11 complete a lighting test. The efficiency of the lighting test is effectively improved, and the difficulty of wiring of the test signal line 30 is low.

In some embodiments of the present disclosure, as shown in FIG. 28, all first test switches 21 are electrically connected to a same test signal line 30.

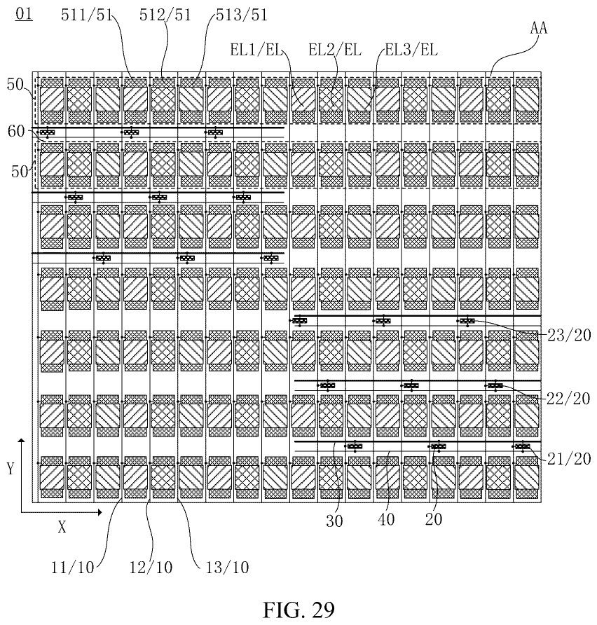

FIG. 29 is a schematic diagram of a display panel according to an embodiment of the present disclosure.

In an embodiment of the present disclosure, as shown in FIG. 29, the at least two first test switches 21 are electrically connected to different test signal lines 30, that is, the at least two second test switches 22 may transmit test signals to the at least two first data lines 11 in a time division mode, so that the first color light-emitting devices EL1 electrically connected to the at least two first data lines 11 complete a lighting test in a time division mode.

In an embodiment of the present disclosure, as shown in FIG. 29, one half of the first test switches 21 and the other half of the first test switches 21 are electrically connected to different test signal lines 30, respectively.

This embodiment can achieve partition lighting test of the first color emitting device EL1 of the display panel 01. For example, as shown in FIG. 29, the test switch 20 electrically connected to the first data line 11 of the left half is connected to one test signal line 30, and the test switch 20 electrically connected to the first data line 11 of the right half is connected to another test signal line 30, so that the left half of the first color emitting device EL1 can be lightened and tested at a same time and the right half of the first color emitting device EL1 can be lightened and tested simultaneously, furthermore, the left half of the first color emitting device EL1 and the right half of the first color emitting device EL1 can be lightened and tested in time division mode.

In an embodiment of the present disclosure, as shown in FIG. 28, the at least two second test switches 22 are connected to a same test signal line 30, that is, the at least two second test switches 22 may simultaneously transmit test signals to the at least two second data lines 12 respectively, so that the second color light-emitting devices EL2 electrically connected to the at least two second data lines 12 to complete the lighting test, effectively improving the efficiency of the lighting test and reducing the difficulty of wiring of the test signal line 30.

In some embodiments of the present disclosure, as shown in FIG. 28, all second test switches 22 are electrically connected to a same test signal line 30.

In an embodiment of the present disclosure, as shown in FIG. 29, the at least two second test switches 22 are electrically connected to different test signal lines 30, that is, the at least two second test switches 22 may transmit test signals to the at least two second data lines 10 in a time division mode, so that the second color light-emitting devices EL2 electrically connected to the at least two second data lines 12 to complete a lighting test in a time division mode.

In some embodiments of the present disclosure, as shown in FIG. 29, one half of the second test switches 22 and the other half of the second test switches 22 are electrically connected to different test signal lines 30, respectively.

This embodiment enables partition lighting test of the second color emitting device EL2 of the display panel 01, for example, as shown in FIG. 29, the test switch 20 electrically connected to the second data line 12 of the left half portion is connected to one test signal line 30, and the test switch 20 electrically connected to the second data line 12 of the right half portion is connected to another test signal line 30, so that the left half of the second color emitting device EL2 can be lightened and tested at a same time and the right half of the first color emitting device EL2 can be lightened and tested at a same time, furthermore, the left half of the second color emitting device EL2 and the right half of the second color emitting device EL2 can be lightened and tested in time division mode.

In some embodiments of the present disclosure, the test switches 20 controlling the light-emitting devices EL of a same color to perform the lighting test may be divided into at least three groups, and the test switches 20 belonging to different groups may be arranged in different spacing regions 60, and the test switches 20 are dispersed in the display region AA, thereby reducing the influence on the display uniformity. In addition, the light-emitting devices EL of a same color are controlled to perform the lighting test, and the test switches 20 located in different groups can be controlled to perform the lighting test on the light-emitting devices EL of a same color in a time division mode.

It should be noted that, when the display panel 01 further includes the third test switch 23, at least two third test switches 23 are electrically connected to a same test signal line 30, and/or at least two third test switches 23 are electrically connected to different test signal lines 30.

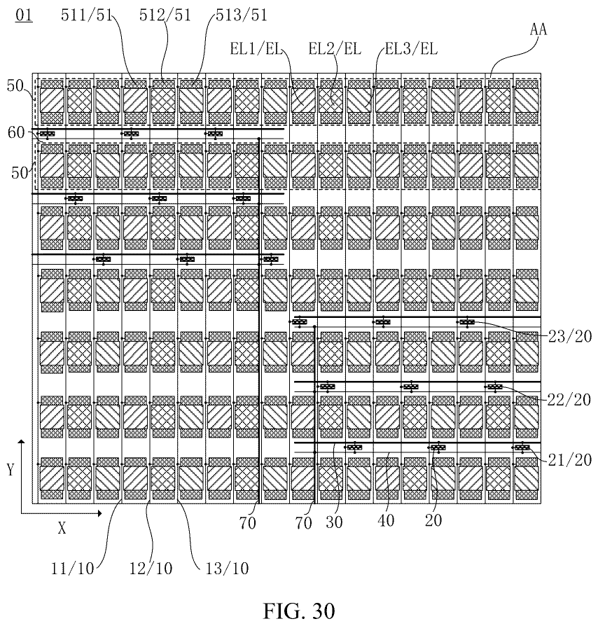

FIG. 30 is a schematic diagram of a display panel according to an embodiment of the present disclosure.

In an embodiment of the present disclosure, as shown in FIG. 30, the test control lines 40 electrically connected to the first test switches 21 connected to different test signal lines 30 are also different, and the first test switches 21 connected to different test signal lines may be respectively controlled by signals on different test control lines 40, thereby improving the flexibility of the lighting test of the first color light-emitting device EL1.

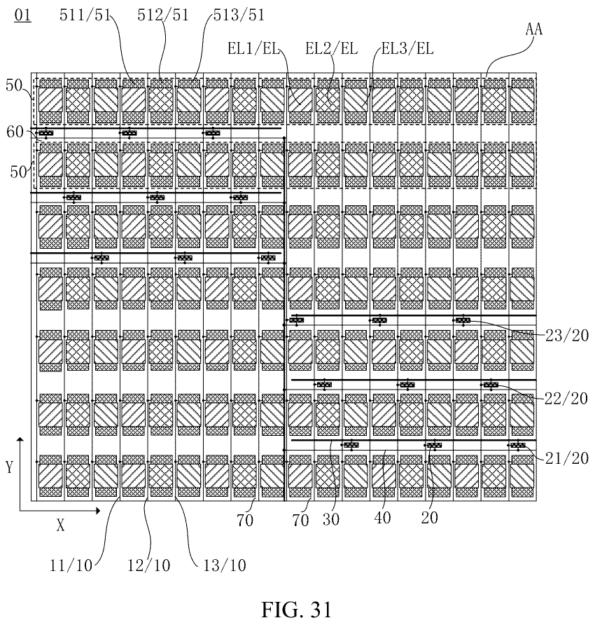

FIG. 31 is a schematic diagram of a display panel according to an embodiment of the present disclosure.

In an embodiment of the present disclosure, as shown in FIG. 31, the test control lines 40 electrically connected to the first test switches 21 connected to different test signal lines 30 may be the same, so that the first test switches 21 connected to different test signal lines may be respectively controlled by signals on a same test control line 40, thereby reducing the number of test control lines 40 while achieving a partition lighting test on the first color light-emitting device EL1.

In an embodiment of the present disclosure, as shown in FIG. 30, the test control lines 40 electrically connected to the second test switches 22 connected to different test signal lines 30 are also different, and the second test switches 22 connected to different test signal lines may be respectively controlled by signals on different test control lines 40, thereby improving the flexibility of the lighting test of the second color light-emitting device EL2.

In an embodiment of the present disclosure, as shown in FIG. 31, the test control lines 40 electrically connected to the test switches 20 connected to different test signal lines 30 may be the same, so that the test switches 20 connected to different test signal lines may be respectively controlled by signals on a same test control line 40, thereby reducing the number of test control lines 40 while achieving the partition lighting test of the second color light-emitting device EL2.

It should be noted that FIG. 28, FIG. 29 and FIG. 30 all illustrate that the first test switch 21 and the second test switch 22 are electrically connected to their respective test signal lines 30 in a same mode. In some embodiments, the first test switch 21 and the second test switch 22 may also be electrically connected to respective test signal lines 30 in different modes, for example, at least two first test switches 21 are electrically connected to different test signal lines 30 and all second test switches 22 are electrically connected to a same test signal line 30, or at least two second test switches 22 are electrically connected to different test signal lines 30 and all first test switches 21 are electrically connected to a same test signal line 30.

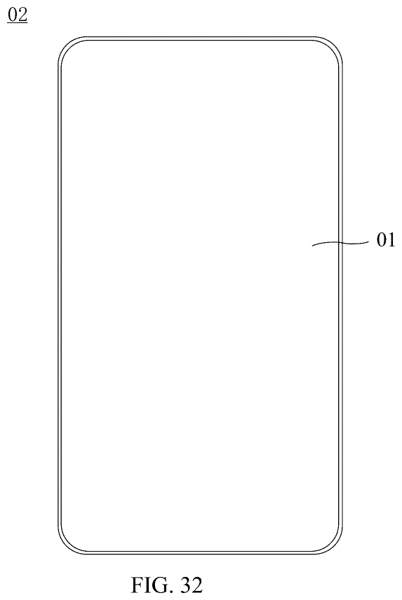

FIG. 32 is a schematic diagram of a display apparatus according to an embodiment of the present disclosure.

The present disclosure provides a display apparatus. As shown in FIG. 32, the display apparatus 02 includes the display panel 01 provided by the above embodiments. The display apparatus 02 provided in the embodiments of the present disclosure may be an electronic device such as a mobile phone, a computer, a television, or a vehicle-mounted display apparatus, which are not limited in the embodiments of this present disclosure.

In some embodiments of the present disclosure, the test switch 20, the test signal line 30, and the test control line 40 in the main structure for achieving the lighting test are provided in the display region AA, thereby avoiding that the test switch 20, the test signal line 30, and the test control line 40 are provided in the lower frame region of the display panel 01, which easily achieves a frameless design of the display panel 01. Therefore, the display apparatus can achieve a very narrow frame and can ensure that the display panel 01 used for the display apparatus 02 reduces the risk of poor display.

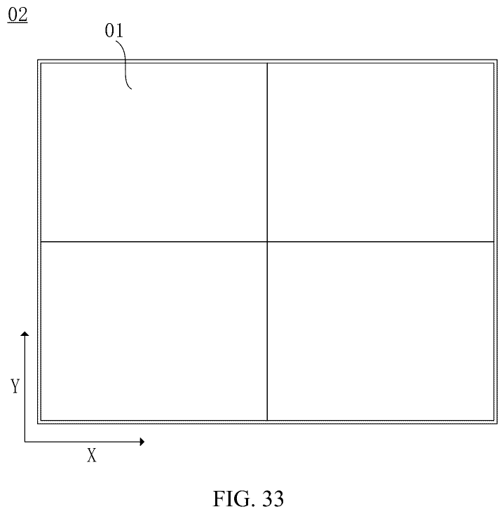

FIG. 33 is a schematic diagram of a display apparatus according to an embodiment of the present disclosure.

In an embodiment of the present disclosure, as shown in FIG. 33, the display apparatus 02 may be formed by adjacently splicing a plurality of display panels 01 provided by the above embodiments along the first direction X and/or the second direction Y. Exemplarily, the spliced display apparatus 02 may be a light-emitting diode splicing screen, a movie screen, a long-distance electronic product, and the like, which is not limited in the embodiments of the present disclosure.

In some embodiments of the present disclosure, the test switch 20, the test signal line 30 and the test control line 40 in the main structure for achieving the lighting test are provided in the display region AA, so that the test switch 20, the test signal line 30 and the test control line 40 are prevented from being provided in the lower frame region of the display panel 01, so that the splicing seam of the display apparatus 02 is easy to be invisible and the display panel 01 used for the display apparatus 02 reduces the risk of poor display.

The above description is only a preferred embodiment of the present disclosure and is not intended to limit the present disclosure, and any modifications, equivalent substitutions, improvements and the like made within the spirit and principle of the present disclosure should be included within the scope of the present disclosure.

What is claimed is:

1. A display panel, having a display region, and comprising in the display region: a plurality of data lines, a plurality of test switches, a plurality of test signal lines and a plurality of test control lines;
wherein one of the plurality of test switches includes an input terminal electrically connected to one of the plurality of test signal lines, an output terminal electrically connected to one of the plurality of data lines, and a control terminal electrically connected to one of the plurality of test control lines.

2. The display panel according to claim 1, wherein the plurality of data lines is arranged along a first direction;
in the display region, the display panel further comprises a plurality of pixel circuit groups arranged along a second direction, one of the plurality of pixel circuit groups comprises a plurality of pixel circuits arranged along the first direction, and the second direction intersects the first direction; and along the second direction, a spacing region is formed between two adjacent pixel circuit groups of the plurality of pixel circuit groups;
wherein the plurality of test switches is located in the spacing region.

3. The display panel according to claim 2, wherein the plurality of test switches electrically connected to a same test signal line is located in a same spacing region; and/or
wherein the plurality of test switches electrically connected to at least two different test signal lines are located in a same spacing region.

4. The display panel according to claim 3, wherein the plurality of test switches electrically connected to different test signal lines are located in different spacing regions; and/or
wherein the plurality of test signal lines and the plurality of test control lines are located in the spacing region.

5. The display panel according to claim 4, wherein the plurality of data lines is arranged along a first direction; and the test signal line and the test control line are in a same layer and extend along the first direction.

6. The display panel according to claim 4, wherein at least two of the plurality of test switches located in a same spacing region and electrically connected to different test signal lines are electrically connected to a same test control line.

7. The display panel according to claim 6, wherein the plurality of test switches electrically connected to a same test control line and electrically connected to different test signal lines are located on two sides of one of the plurality of test control lines.

8. The display panel according to claim 1, further comprising:
a plurality of control connection lines and a first pin, wherein the plurality of test control lines is connected to the first pin through the plurality of control connection lines; and/or
a plurality of signal connection lines and a second pin, wherein the plurality of test signal lines is connected to the second pin through the plurality of signal connection lines.

9. The display panel according to claim 8, wherein,
the plurality of control connection lines is electrically connected to at least two of the plurality of test control lines; and/or,
the plurality of signal connection lines is electrically connected to the plurality of test signal lines in one-to-one correspondence.

10. The display panel according to claim 8, wherein
the plurality of control connection lines and the plurality of data lines are in a same layer and extend in parallel; and/or,
the plurality of signal connection lines and the plurality of data lines are in a same layer and extend in parallel.

11. The display panel according to claim 8, wherein the plurality of data lines is arranged along a first direction;
the display region comprises at least two control connection lines arranged symmetrically about a first symmetry axis, and the first symmetry axis is perpendicular to the first direction and passes through a midpoint of a plane of the display panel; and/or,
the display region comprises at least two signal connection lines arranged symmetrically about a second symmetry axis, and the second symmetry axis is perpendicular to the first direction and passes through the midpoint of the plane of the display panel.

12. The display panel according to claim 8, further comprises:
a first side wiring and a first lower pin located on a side of a backlight surface of the display panel, wherein the first pin is electrically connected to the first lower pin through the first side wiring; and/or,
a second side wiring and a second lower pin located on a side of the backlight surface of the display panel, wherein the second pin is electrically connected to the second lower pin through the second side wiring.

13. The display panel according to claim 8, wherein in the display region, the display panel further comprises a plurality of third pins electrically connected to the plurality of data lines;
one of the plurality of third pins is provided between the first pin and the second pin; and/or,
when more than one first pins are provided, one of the plurality of third pins is provided between two adjacent first pins; and/or,
when more than one second pins are provided, one of the plurality of third pins is provided between two adjacent second pins.

14. The display panel according to claim 8, wherein,
in the display region, the display panel further comprises a driving circuit wiring;
the display panel further comprises a driving circuit connection line and a plurality of fourth pins, and the driving circuit wiring is electrically connected to the plurality of fourth pins through the driving circuit connection line; and
the first pin and/or the second pin are/is comprised between at least two adjacent fourth pins.

15. The display panel according to claim 1, wherein in the display region, the display panel further comprises light-emitting devices and pixel circuits, the light-emitting devices comprise a first color light-emitting device and a second color light-emitting device that have different light-emitting colors, the pixel circuits comprise a first pixel circuit and a second pixel circuit, the first pixel circuit is electrically connected to the first color light-emitting device, and the second pixel circuit is electrically connected to the second color light-emitting device;
the plurality of data lines comprises a first data line and a second data line, the first data line is electrically connected to the first pixel circuit, and the second data line is electrically connected to the second pixel circuit;
the plurality of test switches comprises first test switches and second test switches, an output terminal of one of the first test switches is electrically connected to the first data line, and an output terminal of one of the second test switches is electrically connected to the second data line;
wherein the first test switches and the second test switches are electrically connected to different test signal lines of the plurality of test signal lines, respectively.

16. The display panel according to claim 15, wherein at least two of the first test switches are connected to a same test signal line, and/or at least two of the second test switches are connected to a same test signal line.

17. The display panel according to claim 15, wherein at least two of the first test switches are electrically connected to different test signal lines, and/or at least two of the second test switches are electrically connected to different test signal lines.

18. The display panel according to claim 17, wherein the first test switches connected to different test signal lines are electrically connected to different test control lines; and/or,
the second test switches connected to different test signal lines are electrically connected to different test control lines.

19. The display panel according to claim 1, wherein a width of the test signal line is greater than a width of the test control line.

20. A display apparatus, comprising a display panel, wherein the display apparatus has a display region, and comprises in the display region: a plurality of data lines, a plurality of test switches, a test signal line and a test control line;
wherein one of the plurality of test switches input terminals includes an input terminal electrically connected to the test signal line, an output terminal electrically connected to the plurality of data lines, and a control terminal electrically connected to the test control line.
